(19) United States
(12) Patent Application Publication
(10) Pub. No.: US 2021/0289806 A1
(43) Pub. Date: Sep. 23, 2021

(54) METHOD FOR PRODUCING FOOD

(71) Applicant: J-OIL MILLS, INC., Tokyo (JP)

(72) Inventors: Mina YOSHIMURA, Tokyo (JP); Yuya NAGAHATA, Tokyo (JP); Keisuke SHINODA, Tokyo (JP); Jun IMAGI, Tokyo (JP)

(21) Appl. No.: 17/263,055

(22) PCT Filed: Jul. 26, 2019
(86) PCT No.: PCT/JP2019/029531

§ 371 Date: Jan. 25, 2021

(30) Foreign Application Priority Data
Aug. 3, 2018 (JP) 2018-147253

(51) Int. Cl. A23D 9/007; A23D 9/04; A21D 2/16; A21D 2/18; A23L 13/40; A23L 11/00; A23L 29/212

(52) U.S. Cl. CPC A23D 9/007; A23D 9/04; A21D 2/165; A21D 2/186; A23V 2002/00; A23L 13/426; A23L 11/07; A23L 29/212; A23L 13/43

(57) ABSTRACT

Provided is a method for producing a food, including obtaining a mixture by mixing an edible oil or fat and a component (A) that satisfies a condition of (1): a starch content is equal to or more than 75% by mass, a condition of (2): molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴, a condition of (3): a degree of swelling in cold water at 25° C. is equal to or more than 5 and equal to or less than 20, and a condition of (4): a content under a sieve having an opening of 3.35 mm and on a sieve having an opening of 0.038 mm is equal to or more than 60% by mass and equal to or less than 100% by mass, and obtaining a food composition by blending the mixture in a food material, in which in the obtaining the mixture, a blending amount of the edible oil or fat is equal to or more than 0.02 and equal to or less than 6 in terms of a mass ratio, with respect to the component (A), and a total amount of the edible oil or fat and the component (A) in the mixture is equal to or more than 10% by mass and equal to or less than 100% by mass, with respect to an entirety of the mixture.

### TECHNICAL FIELD

The present invention relates to a method for producing a food.

### BACKGROUND ART

As a food material using starch, there is a material described in Patent Document 1.

Patent Document 1 discloses a composition containing equal to or more than 75% by mass of starch, in which composition contains, as the starch, equal to or more than 3% by mass and equal to or less than 45% by mass of molecular weight-reduced starch obtained by using starch having an amylose content of equal to or more than 5% by mass as a raw material, a peak molecular weight of the molecular weight-reduced starch is equal to or more than 3×10³ and equal to or less than 5×10⁴, a degree of swelling of the composition in cold water at 25° C. is equal to or more than 7 and equal to or less than 20, and a content of a granular material on a sieve having an opening of 0.5 mm in the composition is equal to or less than 50% by mass. The composition has an excellent balance of high water absorption rate, non-stickiness, and an anti-lumping property. For example, when the composition is blended in various foods, it is possible to obtain an excellent texture and good workability.

### RELATED DOCUMENT

### Patent Document

[Patent Document 1] International Publication No. 2014/132534

### SUMMARY OF THE INVENTION

### Technical Problem

However, the above invention does not disclose or suggest that a texture of food can be improved by mixing with edible oil or fat.

### Solution to Problem

Therefore, as a result of intensive studies, the present inventors have found that when a specific component containing starch and edible oil or fat are previously mixed and incorporated in a food, it is possible to improve a texture of the food, and completed the present invention. The texture here refers to a moist feeling, an easiness to bite, and a crumbly texture.

That is, according to the present invention, there is provided a method for producing a food, including: obtaining a mixture by mixing an edible oil or fat and a component (A) that satisfies conditions of (1) to (4) below; and obtaining a food composition by blending the mixture in a food material, in which in the obtaining the mixture, a blending amount of the edible oil or fat is equal to or more than 0.02 and equal to or less than 6 in terms of a mass ratio, with respect to the component (A), and a total amount of the edible oil or fat and the component (A) in the mixture is equal to or more than 10% by mass and equal to or less than 100% by mass, with respect to an entirety of the mixture.

(1) A starch content is equal to or more than 75% by mass;

(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴;

(3) a degree of swelling in cold water at 25° C. is equal to or more than 5 and equal to or less than 20; and

(4) a content under a sieve having an opening of 3.35 mm and on a sieve having an opening of 0.038 mm is equal to or more than 60% by mass and equal to or less than 100% by mass.

The blending amount of the component (A) is preferably equal to or more than 0.5% by mass and equal to or less than 15% by mass in the food composition.

The food is preferably obtainable by heating the food composition.

The food is preferably one selected from the group consisting of a baked confectionery, a processed fish or livestock meat product, a processed fish or livestock meat product-like food, and a bakery food.

A solid fat content of the edible oil or fat at 30° C. is preferably equal to or more than 0% and equal to or less than 20%.

Also, according to the present invention, there is provided a composition including: an edible oil or fat; and a component (A) that satisfies conditions of (1) to (4) below, in which a blending amount of the edible oil or fat is equal to or more than 0.02 and equal to or less than 6 in terms of a mass ratio, with respect to the component (A), and a total amount of the edible oil or fat and the component (A) in the composition is equal to or more than 10% by mass and equal to or less than 100% by mass with respect to an entirety of the composition.

(1) A starch content is equal to or more than 75% by mass;

(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴;

(3) a degree of swelling in cold water at 25° C. is equal to or more than 5 and equal to or less than 20; and

(4) a content under a sieve having an opening of 3.35 mm and on a sieve having an opening of 0.038 mm is equal to or more than 60% by mass and equal to or less than 100% by mass.

The composition is preferably used for one selected from the group consisting of a baked confectionery, a processed fish or livestock meat product, a fish or livestock meat processed-like food, and a bakery food.

Also, according to the present invention, there is provided a method for improving a texture of a food, including: obtaining a food composition by blending, in a food material, a mixture which is obtained by mixing an edible oil or fat with a component (A) that satisfies conditions of (1) to (4) below such that a mass ratio is equal to or more than 0.02 and equal to or less than 6, in which a total amount of the edible oil or fat and the component (A) in the mixture is equal to or more than 10% by mass and equal to or less than 100% by mass, with respect to an entirety of the mixture.

(1) A starch content is equal to or more than 75% by mass;

(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴;

(3) a degree of swelling in cold water at 25° C. is equal to or more than 5 and equal to or less than 20; and

(4) a content under a sieve having an opening of 3.35 mm and on a sieve having an opening of 0.038 mm is equal to or more than 60% by mass and equal to or less than 100% by mass.

The blending amount of the component (A) is preferably equal to or more than 0.5% by mass and equal to or less than 15% by mass in the food composition.

A predetermined combination of each of these configurations, or a case obtained by changing the expression of the present invention among a method, a device, and the like is also effective as an aspect of the present invention.

For example, the present invention also includes a baked confectionery, a processed fish or livestock meat product, a processed fish or livestock meat product-like food, a bakery food which are obtainable by the production method of the present invention.

### Advantageous Effects of Invention

According to the present invention, it is possible to improve a texture of a food.

### DESCRIPTION OF EMBODIMENTS

For example, according to a production method of the present invention, it is possible to obtain a baked confectionery, a bakery food, a processed fish or livestock meat product, a fish or livestock meat processed-like food, and the like which have improved moist feeling, easiness to bite, and crumbly texture. The “moist feeling” here refers to a feeling that the food contains an appropriate amount of moisture and is not dry. The “easiness to bite” refers to a feeling of crispy cutting when biting a food with your teeth. The “crumbly texture” refers to a feeling of easily loosening and breaking in a mouth when chewing a food.

Hereinafter, embodiments of the present invention will be described with reference to specific examples of each component. Each component may be used alone or two or more kinds thereof may be used in combination.

(Mixture)

In the present embodiment, a mixture contains an edible oil or fat and a component (A) that satisfies the following conditions of (1) to (4). Also, a blending amount of the edible oil or fat in the mixture is equal to or more than 0.02 and equal to or less than 6 in terms of a mass ratio, with respect to the component (A). In addition, a total amount of the edible oil or fat and the component (A) in the mixture is equal to or more than 10% by mass and equal to or less than 100% by mass with respect to an entirety of the mixture.

(1) Starch content is equal to or more than 75% by mass

(2) Molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴

(3) A degree of swelling in cold water at 25° C. is equal to or more than 5 and equal to or less than 20

(4) A content under a sieve having an opening of 3.35 mm and on a sieve having an opening of 0.038 mm is equal to or more than 60% by mass and equal to or less than 100% by mass

Hereinafter, the component (A) will be described in more detail.

(Component (A))

Specifically, the component (A) contains starch as a main component.

Regarding the condition of (1), the component (A) contains the starch in an amount of equal to or more than 75% by mass, preferably equal to or more than 80% by mass, and still more preferably equal to or more than 85% by mass, from a viewpoint of improving the texture of the food.

Also, an upper limit of the starch content in the component (A) is not limited and is equal to or less than 100% by mass, or may also be, for example, equal to or less than 99.5% by mass and equal to or less than 99% by mass, according to properties of the food.

Regarding the condition of (2), the molecular weight-reduced starch is contained in the starch under the condition of (1).

The peak molecular weight of the molecular weight-reduced starch is equal to or more than 3×10³, and preferably equal to or more than 8×10³, from the viewpoint of improving the texture of food. Also, from the same viewpoint, the peak molecular weight of the molecular weight-reduced starch is equal to or less than 5×10⁴, preferably equal to or less than 3×10⁴, and still more preferably equal to or less than 1.5×10⁴. A measurement method of the peak molecular weight of the molecular weight-reduced starch will be described in a section of Examples.

From a viewpoint of excellent production stability, the molecular weight-reduced starch is preferably one or more selected from the group consisting of acid-treated starch, oxidation-treated starch, or enzyme-treated starch, and more preferably the acid-treated starch.

A condition of the acid treatment is not limited, and the treatment can be performed as follows, for example.

The starch having the amylose content of equal to or more than 5% by mass and water are added to a reaction device, and then acid is further added thereto. Alternatively, acid water, in which an inorganic acid is previously dissolved in water, and the starch as a raw material are added to the reaction device. From a viewpoint of more stably performing the acid treatment, it is desirable that a total amount of the starch in the reaction is in a state of being uniformly dispersed in an aqueous phase or in a slurry state. Thus, a concentration of the starch slurry in the acid treatment is adjusted to be in a range, for example, equal to or more than 10% by mass and equal to or less than 50% by mass, and preferably equal to or more than 20% by mass and equal to or less than 40% by mass. When the slurry concentration is too high, slurry viscosity may increase, and it may be difficult to stir the slurry uniformly, in some cases.

Specific examples of the acid used for the acid treatment include inorganic acids such as hydrochloric acid, sulfuric acid, and nitric acid, which can be used regardless of a kind, purity, and the like.

In the acid treatment reaction, for example, a concentration of the inorganic acid during the acid treatment is preferably equal to or more than 0.05 Normality (N) and equal to or less than 4 N, more preferably equal to or more than 0.1 N and equal to or less than 4 N, and still more preferably equal to or more than 0.2 N and equal to or less than 3 N. In addition, a reaction temperature is preferably equal to or higher than 30° C. and equal to or lower than 70° C., more preferably equal to or higher than 35° C. and equal to or lower than 70° C., and still more preferably equal to or higher than 35° C. and equal to or lower than 65° C. A reaction time is preferably equal to or longer than 0.5 hours and equal to or shorter than 120 hours, more preferably equal to or longer than 1 hour and equal to or shorter than 72 hours, and still more preferably equal to or longer than 1 hour and equal to or shorter than 48 hours.

A lower limit of a content of the molecular weight-reduced starch in the component (A) is equal to or more than 3% by mass, preferably equal to or more than 8% by mass, and still more preferably equal to or more than 13% by mass, from the viewpoint of improving the texture of the food.

On the other hand, an upper limit of the content of the molecular weight-reduced starch in the component (A) is equal to or less than 45% by mass, preferably equal to or less than 35% by mass, and still more preferably equal to or less than 25% by mass, from the same viewpoint.

In addition, a lower limit of the amylose content in the raw material starch of the molecular weight-reduced starch is, from the viewpoint of improving the texture of the food, equal to or more than 5% by mass, preferably equal to or more than 12% by mass, more preferably equal to or more than 22% by mass, still more preferably equal to or more than 45% by mass, still further preferably equal to or more than 55% by mass, and even more preferably equal to or more than 65% by mass. An upper limit of the amylose content in the raw material starch of the molecular weight-reduced starch is not limited, and is equal to or less than 100% by mass, preferably equal to or less than 90% by mass, and more preferably equal to or less than 80% by mass.

As the starch which is the raw material of the molecular weight-reduced starch and has the amylose content of equal to or more than 5% by mass, one or more selected from the group consisting of high amylose corn starch, corn starch, tapioca starch, sweet potato starch, potato starch, wheat starch, high amylose wheat starch, rice starch, and processed starch obtained by processing these raw materials chemically, physically, or enzymatically can be used. From the viewpoint of improving the texture of the food, it is preferable to use one or more selected from high amylose corn starch, corn starch, and tapioca starch. Also, from the same viewpoint, the starch having the amylose content of equal to or more than 5% by mass is preferably the high amylose corn starch. The high amylose corn starch having the amylose content of equal to or more than 40% by mass is available. The starch having the amylose content of equal to or more than 5% by mass is more preferably corn starch having the amylose content of equal to or more than 40% by mass.

Also, the component (A) has a configuration in which the degree of swelling in cold water satisfies the specific condition of (3) and a particle size satisfies the specific condition of (4).

First, regarding the condition of (3), from the viewpoint of improving the texture of the food, the degree of swelling of the component (A) in cold water is equal to or more than 5, preferably equal to or more than 6, and still more preferably equal to or more than 6.5.

In addition, from the same viewpoint, the degree of swelling of the component (A) in cold water is equal to or less than 20, preferably equal to or less than 17, and still more preferably equal to or less than 15.

Here, a measurement method of the degree of swelling of the component (A) in cold water will be described in a section of Examples.

Next, the particle size for the component (A) will be described.

Regarding the condition of (4), the content under a sieve having an opening of 3.35 mm and on a sieve having an opening of 0.038 mm is equal to or more than 60% by mass, preferably equal to or more than 80% by mass, more preferably equal to or more than 85% by mass, and still more preferably equal to or more than 90% by mass, and even more preferably equal to or more than 95% by mass with respect to the entirety of the component (A), from the viewpoint of improving the texture of the food.

In addition, an upper limit of the content under a sieve having an opening of 3.35 mm and on a sieve having an opening of 0.038 mm is not limited and, for example, equal to or less than 100% by mass.

In addition, in a case where the food is a baked confectionery or a bakery food, the content under a sieve having an opening of 0.15 mm and on a sieve having an opening of 0.075 mm is preferably equal to or more than 20% by mass and equal to or less than 80% by mass and more preferably equal to or more than 35% by mass and equal to or less than 65% by mass. In a case where the food is the processed fish or livestock meat product of the processed fish or livestock meat product-like food, the content under a sieve having an opening of 1 mm and on a sieve having an opening of 0.5 mm is preferably equal to or more than 15% by mass and equal to or less than 70% by mass and more preferably equal to or more than 30% by mass and equal to or less than 60% by mass.

Here, regarding the particle size of the component (A), a content of a fraction on or under the sieve is a content of the fraction with respect to the entirety of the component (A). Also, the sieve is specifically a sieve in the JIS-Z8801-1 standard.

In the present embodiment, various starches may be used as a starch component other than the molecular weight-reduced starch in the component (A). Specifically, starch generally available on the market may be selected depending on use. For example, in a case of starch for foods, regardless of a kind, one or more kinds of starch such as corn starch, potato starch, tapioca starch, and wheat starch; processed starch obtained by processing these starch chemically, physically, or enzymatically; and the like may be appropriately selected. Preferably, one or more starch selected from the group consisting of the corn starch, the wheat starch, the potato starch, the tapioca starch, and cross-linked starch thereof may be contained, and more preferably the corn starch may be contained.

In addition, a component other than the starch can be blended with the component (A) in the present embodiment.

Specific examples of the component other than the starch include a pigment and an insoluble salt such as calcium carbonate, and calcium sulfate. It is preferable to blend the insoluble salt, and it is more preferable that a blending amount of the insoluble salt is equal to or more than 0.1% by mass and equal to or less than 2% by mass.

Next, a method for producing the component (A) will be described. The method for producing the component (A) includes, for example, the following steps.

(Preparing molecular weight-reduced starch) A step of reducing the molecular weight of the starch having the amylose content of equal to or more than 5% by mass to obtain the molecular weight-reduced starch having a peak molecular weight of equal to or more than 3×10³ and equal to or less than 5×10⁴.

(Granulation) A step of granulating, by heat gelatinization, the raw material in which equal to or more than 3% by mass and equal to or less than 45% by mass of the molecular weight-reduced starch is contained, and the total amount of molecular weight-reduced starch and starch other than the molecular weight-reduced starch is equal to or more than 75% by mass.

The step of preparing the molecular weight-reduced starch is a step of decomposing the starch having the amylose content of equal to or more than 5% by mass into the molecular weight-reduced starch. The decomposition referred to here refers to decomposition accompanied by molecular weight reduction of starch, and examples of a typical decomposition methods include decomposition by an acid treatment, an oxidation treatment, and an enzyme treatment. Among the treatments, the acid treatment is preferable from the viewpoints of a decomposition rate, costs, and reproducibility of a decomposition reaction.

Further, in the granulation step, a general method used for granulating starch may be used, and it is preferable to use a general method used for heat gelatinization of starch, in terms of achieving a predetermined degree of swelling in cold water. Specifically, a method using a machine such as a drum dryer, a jet cooker, an extruder, or a spray dryer is known. In the present embodiment, from the viewpoint of more reliably obtaining the component (A) in which the degree of swelling in cold water satisfies the above-mentioned specific condition, the heat gelatinization with the extruder or the drum dryer is preferable, and the extruder is more preferable.

In a case of an extruder treatment, usually, water is added to a raw material containing starch to adjust the moisture content to about 10% to 60% by mass, and then heated and swelled, for example, in conditions of a barrel temperature of 30° C. to 200° C., an outlet temperature of 80° C. to 180° C., a screw rotation speed of 100 to 1,000 rpm, and a heat treatment time of 5 to 60 seconds.

In the present embodiment, for example, by the step of heat-gelatinizing the specific raw material, the component (A) in which the degree of swelling in cold water satisfies a specific condition can be obtained.

In addition, the component (A) satisfying the condition of (4) may be obtainable by, as needed, pulverizing and sieving a granulated product obtained by heat gelatinization and appropriately adjusting a size thereof.

The component (A) obtainable as described above is mixed with the edible oil or fat to obtain the mixture. A method for mixing the component (A) with the edible oil or fat is not limited. In a case where the edible oil or fat has a high melting point, it is preferable previously to heat the edible oil or fat to make the edible oil or fat in a liquid state, and then mix therewith. In addition, from the viewpoint of improving workability, the edible oil or fat has a solid fat content (SFC) at 30° C. of preferably equal to or more than 0% and equal to or less than 20%, more preferably equal to or more than 0% and equal to or less than 10%, and still more preferably equal to or more than 0% and equal to or less than 5%. Also, the SFC at 10° C. is preferably equal to or more than 0% and equal to or less than 60%, more preferably equal to or more than 0% and equal to or less than 45%, and still more preferably equal to or more than 0% and equal to or less than 20%. Accordingly, an effect of improving the texture of the food is obtainable more stably. The SFC can be measured by a method of AOCS Official Method Cd 16b-93.

Furthermore, slip melting point of the edible oil or fat is preferably equal to or lower than 40° C., more preferably equal to or lower than 20° C., and still more preferably equal to or lower than 0° C. The slip melting can be measured according to the Standard Methods for the Analysis of Fats, Oils and Related Materials 2. 2. 4. 2-1996.

Specific examples of the edible oil or fat will be described later.

The mixture may be formed of the component (A) and the edible oil or fat.

In addition, the total amount of the edible oil or fat and the component (A) in the mixture is equal to or more than 10% by mass, preferably equal to or more than 20% by mass, more preferably equal to or more than 30% by mass, still more preferably equal to or more than 40% by mass, still further preferably equal to or more than 50% by mass, even more preferably equal to or more than 70% by mass, and even further preferably equal to or more than 80% by mass, with respect to the entirety of the mixture. The total amount of the edible oil or fat and the component (A) in the mixture may be equal to or less than 100% by mass, for example, equal to or less than 99% by mass, or equal to or less than 95% by mass, with respect to the entirety of the mixture.

In the step of obtaining the mixture, the blending amount of the edible oil or fat is equal to or more than 0.02 and equal to or less than 6, preferably equal to or more than 0.02 and equal to or less than 5, more preferably equal to or more than 0.02 and equal to or less than 4.5, and still more preferably equal to or more than 0.05 and equal to or less than 4, in terms of a mass ratio, with respect to the component (A). Accordingly, the effect of improving the texture of the food is obtainable more stably. From the same viewpoint, the blending amount of the edible oil or fat is equal to or more than 0.02, preferably equal to or more than 0.05, and equal to or less than 6, preferably equal to or less than 5, more preferably equal to or less than 4.5, and still more preferably equal to or less than 4, in terms of a mass ratio, with respect to the component (A).

Also, in a case where the food is the baked confectionery or the bakery food, the blending amount of the edible oil or fat is preferably equal to or more than 0.02 and equal to or less than 4, more preferably equal to or more than 0.02 and equal to or less than 2, and still more preferably equal to or more than 0.02 and equal to or less than 1, in terms of a mass ratio, with respect to the component (A). In a case where the food is the processed fish or livestock meat product or the processed fish or livestock meat product-like food, the blending amount of the edible oil or fat is preferably equal to or more than 0.1 and equal to or less than 6, more preferably equal to or more than 0.5 and equal to or less than 6, and still more preferably equal to or more than 0.8 and equal to or less than 6, in terms of a mass ratio, with respect to the component (A).

(Edible Oil or Fat)

Specific examples of edible oil and fat in the present embodiment include a vegetable oil and fat such as a palm kernel oil, a palm oil, a coconut oil, a corn oil, a cottonseed oil, a soybean oil, a rapeseed oil, a rice oil, a sunflower oil, a safflower oil, a cacao oil, and a sesame oil, an animal oil and fat such as lard, and medium chain fatty acid triglyceride. Also, a processed oil and fat such as fractionated oils thereof (such as mid-melting point part of the palm oil, fractionated soft oil of the palm oil, and fractionated hard oil of the palm oil), a transesterified oil, a hydrogenated oil, and the like can be used. The edible oil or fat preferably contains one or more selected from the rapeseed oil, the corn oil, the soybean oil, the palm oil, and a palm fractionated oil, in an amount of equal to or more than 70% by mass and equal to or less than 100% by mass, and more preferably contains one or more selected from the rapeseed oil, the corn oil, the soybean oil, and a palm olein, in an amount of equal to or more than 70% by mass and equal to or less than 100% by mass.

(Food Composition)

The mixture obtainable by mixing the component (A) obtained as described above and edible oil or fat is blended with a food material to obtain a food composition. The method of blending the mixture with the food material to obtain the food composition is not limited, and the blending method suitable for each food may be used.

When the mixture is blended with the food material to obtain the food composition, a blending amount of the component (A) is preferably equal to or more than 0.5% by mass and equal to or less than 15% by mass, more preferably equal to or more than 0.8% by mass and equal to or less than 12% by mass, and still more preferably equal to or more than 1.0% by mass and equal to or less than 10% by mass, in the food composition. Accordingly, the effect of improving the texture of the food is obtainable more stably. From the same viewpoint, the blending amount of the component (A) is preferably equal to or more than 0.5% by mass, more preferably equal to or more than 0.8% by mass, and still more preferably equal to or more than 1.0% by mass, and is preferably equal to or less than 15% by mass, more preferably equal to or less than 12% by mass, and still more preferably equal to or less than 10% by mass, in the food composition.

The obtained food composition may be eaten as a food as it is or may obtain a food by heat-cooking, and it is preferable that the food composition is heat-cooked. In addition, the method for producing a food may further include obtaining a food by heat-cooking the food composition, after the obtaining the food composition. Specific examples of the heat-cooking include baking, boiling, steaming, steam convection heating, deep-frying. One or more types of heat-cooking selected from the baking, the steam convection heating, and steaming are preferable, and one or two types of heat-cooking selected from the baking and steam convection heating are preferable.

(Food)

The food in the present embodiment is not limited, and specific examples thereof include a baked confectionery such as madeleine, financier, a pound cake, a sponge cake, a chiffon cake, a cookie, a donut, and kouglof; bakery foods such as bread, sweet bread, Danish pastry, pies, French bread, savoury bread (filled or stuffed bread), and pizza; and processed fish or livestock meat products and processed fish such as hamburger steak, minced meat cutlet, sausage, meat loaf, gyoza (dumplings), shumai, meatball, kamaboko, and Hanpen or livestock meat product-like food. One kind selected from the group consisting of the baked confectionery, the bakery food, the processed fish or livestock meat product, and the processed fish or livestock meat product-like food is preferable.

Here, the fish or livestock meat processed-like food is a food that uses substitute meat, cultured meat, or the like instead of meat or fish. Examples of a raw material for the fish or livestock meat processed-like food include plant proteins such as soybean protein, pea protein, wheat flour gluten, and seaweed protein; and insect protein.

In addition, from the viewpoint of more stably obtaining the effect of improving the texture of the food, the food is preferably obtainable by heating the food composition described above.

(Food Material)

A food material in the present embodiment is not limited as long as it is a food material normally used for a food. Specific examples thereof include cereal flour such as wheat flour and soybean flour; grains such as rice, wheat, and soybeans; vegetables; fruit; livestock meat, and minced meat thereof, fish meat and fish paste, tuna, tofu, proteins such as gluten and soy protein; sugars such as sugar, fructose, glucose, high fructose corn syrup, invert sugar, oligosaccharides, starch, dextrin, trehalose, and sugar alcohol; sweeteners such as aspartame, acesulfame potassium, advantame, sucralose, alitame, neotame, saccharin, and stevia extract; dietary fiber such as bran, cellulose, and indigestible dextrin; leavening agents such as baking powder; edible oil and fat such as margarine, shortening, rapeseed oil, and soybean oil; milks such as milk, skim milk powder, full-fat milk powder, cheese, and yogurt; eggs such as whole eggs and whole egg powder; thickening polysaccharides such as guar gum and alginate; emulsifier; flavoring material such as cocoa powder and matcha powder; and the like.

The food material may contain components in common with those contained in the mixture.

(Composition)

In the present embodiment, the composition contains the edible oil or fat and the component (A), and may contain other components. When the component is contained, it is preferable that the edible oil or fat and the component (A) are mixed in advance, and then the component is mixed therewith to obtain the composition. Examples of the component include liquid components such as water and seasoning liquid, and powder seasonings such as salt. In a case where the food is the processed fish or livestock meat product or the processed fish or livestock meat product-like food, the composition preferably contains the liquid component, and a blending amount of the liquid component is preferably equal to or more than 0.5 and equal to or less than 4, and more preferably equal to or more than 0.5 and equal to or less than 2.5, in terms of a mass ratio, with respect to the component (A). In addition, the liquid component is preferably one or two kinds selected from water and seasoning liquid, and more preferably the water.

The composition is synonymous with the mixture in the method for producing a food product and the method for improving the texture of a food according to the present embodiment.

A total amount of a seasoning oil and the component (A) in the composition is equal to or more than 10% by mass and equal to or less than 100% by mass with respect to an entirety of the composition.

The total content of the edible oil or fat and the component (A) in the composition is preferably equal to or more than 50% by mass, more preferably equal to or more than 70% by mass, and still more preferably equal to or more than 80% by mass with respect to the entirety of the composition. Further, an upper limit of the total content of the edible oil or fat and the component (A) in the composition is equal to or less than 100% by mass, and may be equal to or less than 99% by mass and equal to or less than 95% by mass.

Also, the total content of the edible oil or fat and the component (A) in the composition may be equal to or more than 10% by mass, and may be preferably equal to or more than 20% by mass, more preferably equal to or more than 30% by mass, and still further preferably equal to or more than 40% by mass, with respect to the entirety of the composition.

The composition is suitably used for those exemplified in the section (Food), and is preferably used for one selected from the group consisting of a baked confectionery, a bakery food, a processed fish or livestock meat product, and a processed fish or livestock meat product-like food.

The mixture in which the edible oil or fat is mixed with the component (A) such that a mass ratio is equal to or more than 0.02 and equal to or less than 6, preferably equal to or more than 0.02 and equal to or less than 5, more preferably equal to or more than 0.02 and equal to or less than 4.5, and still more preferably equal to or more than 0.05 and equal to or less than 4 is blended with a food material to obtain the food composition, whereby it is possible to improve the texture of the food. From the viewpoint of the same viewpoint, the blending amount of the edible oil or fat is equal to or more than 0.02, preferably equal to or more than 0.05, and equal to or less than 6, preferably equal to or less than 5, more preferably equal to or less than 4.5, and still more preferably equal to or less than 4, in terms of a mass ratio, with respect to the component (A).

Also, in a case where the food is the baked confectionery or the bakery food, the blending amount of the edible oil or fat is preferably equal to or more than 0.02 and equal to or less than 4, more preferably equal to or more than 0.02 and equal to or less than 2, and still more preferably equal to or more than 0.02 and equal to or less than 1, in terms of a mass ratio, with respect to the component (A). In a case where the food is the processed fish or livestock meat product or the processed fish or livestock meat product-like food, the blending amount of the edible oil or fat is preferably equal to or more than 0.1 and equal to or less than 6, more preferably equal to or more than 0.5 and equal to or less than 6, and still more preferably equal to or more than 0.8 and equal to or less than 6, in terms of a mass ratio, with respect to the component (A).

### EXAMPLES

Examples of the present invention will be shown below, but the gist of the present invention is not limited thereto.

(Raw Material)

The following raw materials were mainly used.

(Starch)

β-starch (corn starch): Corn starch Y, manufactured by J-OIL MILLS, INC.

High amylose corn starch: HS-7, manufactured by J-OIL MILLS, INC., amylose content of 70% by mass

(Edible Oil or Fat)

Edible oil or fat 1: Rapeseed oil (manufactured by J-OIL MILLS, INC.)

Edible oil or fat 2: Palm oil (manufactured by J-OIL MILLS, INC.)

Edible oil or fat 3: Oil obtained by mixing rapeseed oil and palm olein (iodine value 67) at 90:10

(Processed Oil or Fat)

Processed oil or fat 1: Gran master Alfille, manufactured by J-OIL MILLS, INC.

Processed oil or fat 2: “Splendor L”, manufactured by J-OIL MILLS, INC.

Here, the processed oil or fat is a food oil or fat added in a step other than the step of preparing the mixture food.

(Others)

Soft flour: Flour, manufactured by Nisshin Foods Inc.

Baking powder: F-up, manufactured by Aikoku Co., Ltd.

Sugar 1: Granulated sugar, manufactured by Mitsui Sugar Co., Ltd.

Sugar 2: Powdered sugar, manufactured by Nissin Sugar Co., Ltd.

Also, Table 1 shows the solid fat content (SFC), and the slip melting point of edible oils or fats 1 to 3 below.

(Measurement Method of SFC)

Measurement was performed according to AOCS Official Method Cd 16b-93. Specifically, edible oil or fat was quantitatively filled in a glass tube for NMR, and kept warm for 30 minutes in a constant temperature bath at 60° C. After keeping the temperature at 0° C. for 1 hour, the oil or fat was transferred to a constant temperature bath whose temperature was controlled. After 30 minutes, the solid fat content (SFC) (%) was measured using an NMR analyzer (the minispec, mq 20 NMR Analyzer, manufactured by BRUKER).

(Measurement Method of Slip Melting Point)

The measurement was carried out according to the standard oil or fat analysis test method 2. 2. 4. 2-1996.

TABLE 1

| | SFC (%) at | SFC (%) at | Slip melting |
|---|---|---|---|
| Kind of edible oil or fat | 30° C. | 10° C. | point (° C.) |
| Edible oil or fat 1 | 0 | 0 | Lower than 0 |
| Edible oil or fat 2 | 8.5 | 50 | 32.2 |
| Edible oil or fat 3 | 0 | 0 | Lower than 0 |

### (Production Example 1) Production of Component (A)

In the present example, acid-treated starch was used as the molecular weight-reduced starch to obtain the component (A).

(Method for Producing Acid-Treated High-Amylose Corn Starch)

High amylose corn starch was suspended in water to prepare 35.6% (w/w) slurry, and was heated to 50° C. A reaction was started by adding an aqueous hydrochloric acid solution prepared to be 4.25 N in an amount of 1/9 times in terms of a mass ratio of the slurry while stirring. After reacting for 16 hours, it was neutralized with 3% NaOH, washed with water, dehydrated, and dried to obtain acid-treated high-amylose corn starch.

The peak molecular weight of the obtained acid-treated high-amylose corn starch was measured by a method below, as a result, the peak molecular weight was 1.2×10⁴.

(Method for Measuring Peak Molecular Weight)

The peak molecular weight was measured using an HPLC unit manufactured by Tosoh Corporation (Pump DP-8020, RI detector RS-8021, and Degassing device SD-8022).

(1) A sample was pulverized, and a fraction under a sieve having an opening of 0.15 mm was collected using a sieve of JIS-Z8801-1 standard. This collected fraction was suspended in a mobile phase so as to be 1 mg/mL, and the suspension was heated at 100° C. for 3 minutes to completely dissolve. Filtration was performed using a 0.45 μm filtration filter (manufactured by ADVANTEC, DISMIC-25HP PTFE 0.45 μm), and a filtrate was used as an analytical sample.

(2) A molecular weight was measured under the following analysis conditions.

Column: Two columns of TSKgel α-M (7.8 mmφ, 30 cm) (made by Tosoh Corporation)

Flow rate: 0.5 mL/min

Mobile phase: 5 mM NaNO₃-containing dimethyl sulfoxide solution at 90% (v/v)

Column temperature: 40° C.

Analytical volume: 0.2 mL

(3) The detector data was collected by software (multi-station GPC-8020 model II data collection ver 5.70, manufactured by Tosoh Corporation), and the molecular weight peak was calculated.

For a calibration curve, Pullulan with a known molecular weight (Shodex Standard P-82, manufactured by Showa Denko KK) was used.

(Method for Producing Component (A))

79% by mass of β-starch, 20% by mass of acid-treated high-amylose corn starch obtained by the above method, and 1% by mass of calcium carbonate were mixed in a bag to be sufficiently uniform. A mixture was heat-treated under pressure using a twin-screw extruder (KEI-45 manufactured by Kowa Industry Co., Ltd.). Processing conditions are as follows.

Raw material supply: 450 g/min

Water addition: 17% by mass

Barrel temperature: 50° C., 70° C., and 100° C. from the raw material inlet to the outlet

Outlet temperature: 100° C. to 110° C.

Screw rotation speed of 250 rpm

A heat-gelatinized product obtained by the extruder treatment in this manner was dried at 110° C. to adjust the moisture content to about 10% by mass.

Next, the dried heat-gelatinized product was pulverized with a desktop cutter pulverizer and then sieved using a sieve of JIS-Z8801-1 standard. The sieved heat-gelatinized product was mixed at a blending ratios of Table 2 to prepare two kinds of components (A) (A1 and A2) below.

In addition, when the degree of swelling of the component (A) in cold water was measured by the method to be described later, the component A1 was 7.3 and the component A2 was 7.8.

(Method for Measuring Degree of Swelling in Cold Water)

(1) A sample was dried by heating at 125° C. using a moisture meter (model number MX-50, manufactured by Kensei Kogyo Co., Ltd.) to measure the moisture, and the mass of dry matter was calculated from a moisture value obtained.

(2) 1 g of the sample in terms of the mass of dry matter was in a state of being dispersed in 50 mL of water at 25° C., gently stirred in a constant temperature bath at 25° C. for 30 minutes, and then centrifuged at 3000 rpm for 10 minutes (Centrifuge: Hitachi desktop centrifuge CT6E type, manufactured by Hitachi Koki Co., Ltd.; Rotor: T4SS type swing rotor; and Adapter: 50TC×2S adapter), and separated into a sediment layer and a supernatant layer.

(3) The supernatant layer was removed, the mass of the sediment layer was measured, and this mass was set as B (g).

(4) The mass when the sediment layer was dried and solidified (105° C., constant weight) was set as C (g).

(5) A value obtained by dividing B by C was set as the degree of swelling in cold water.

TABLE 2

| | Component (A): A1 | Component (A): A2 |
|---|---|---|
| Fraction | (% by mass) | (% by mass) |
| Under 3.35 mm sieve and on | | 0.2 |
| 1.4 mm sieve | | |
| Under 1.4 mm sieve and on 1 | | 13.2 |
| mm sieve | | |
| Under 1 mm sieve and on 0.5 | | 38.5 |
| mm sieve | | |
| Under 0.5 mm sieve and on | | 19.5 |
| 0.25 mm sieve | | |
| Under 0.25 mm sieve and on | 36.4 | 10.4 |
| 0.15 mm sieve | | |
| Under 0.15 mm sieve and on | 48.0 | 13.7 |
| 0.075 mm sieve | | |
| Under 0.075 mm sieve and on | 11.4 | 3.3 |
| 0.038 mm sieve | | |
| Under 0.038 mm sieve | 4.2 | 1.2 |

Note)
For example, “Under 3.35 mm sieve and on 1.4 mm sieve” means “under a sieve having an opening of 3.35 mm and on a sieve having an opening of 1.4 mm of JIS-Z8801-1 standard”.

### Experiment 1

In the present example, Madeleine was prepared and evaluated.

(Method for Producing Madeleine)

(Case of Examples)

1. The component (A) and the edible oil or fat were mixed according to a blend shown in Table 3, and further sheared using a food processor to obtain a mixture.

2. Soft flour, the baking powder, and sugar 1 were put in a plastic bag and mixed to obtain a mixed flour.

3. The whole egg, the mixture obtained in 1, and the mixed flour obtained in 2 were placed in a bowl and stirred uniformly with a hobart mixer equipped with a beater.

4. Processed oil or fat 1 melted by heating at 50° C. was added, and was uniformly stirred.

5. The dough was placed at 25° C. for 1 hour.

6. The dough was put into a pastry bag, and the dough was poured into a madeleine mold (12 pieces, length 260 mm, width 180 mm, height 15 mm, made of silicon-treated tin) and baked in an oven under the following conditions to obtain a madeleine.

Baking temperature: Upper part 180° C./Lower part 180° C.

Baking time: For 11 minutes

(Case of Comparative Example)

For each comparative example, a madeleine was obtained with the same operation, except that, in the (Case of Examples), the operation of 1 was not performed, and the operation of 3 was set such that “the component (A) and the edible oil or fat were added to the whole egg, were placed in a bowl together with two mixed flours, and stirred uniformly with a hobart mixer equipped with a beater.”

(Evaluation Method)

In the following, the madeleines prepared in each example were evaluated for moist feeling, easiness to bite, and crumbly texture by the consensus of three specialized panelists. In addition, the workability of the food composition was evaluated by one worker from the viewpoint of stickiness of the dough. A score of equal to or higher than 3 was set as a pass. Evaluation criteria are shown below.

(Moist Feeling)

5: Very moist

4: Moist

3: Slightly moist

2: Feel slightly dryness

1: Feel considerable dryness

(Easiness to Bite)

5: Very easy to bite

4: Easy to bite

3: Slightly easy to bite

2: Not very easy to bite

1: Not easy to bite

(Crumbly Texture)

5: Crumbly texture is very strong

4: Crumbly texture is strong

3: Crumbly texture is slight

2: Crumbly texture is weak

1: Crumbly texture is none

(Workability of Food Composition)

5: No stickiness at all

4: Almost no stickiness

3: Not very sticky

2: Slightly sticky

1: Very sticky

TABLE 3

| | | Comparative | | Comparative | | Comparative | |
|---|---|---|---|---|---|---|---|
| Raw material (part(s) by mass) | | Example 1 | Example 1 | Example 2 | Example 2 | Example 3 | Example 3 |
| Powder raw | Soft flour | 100 | 100 | 100 | 100 | 100 | 100 |
| material | Sugar 1 | 100 | 100 | 100 | 100 | 100 | 100 |
| | Baking powder | 3 | 3 | 3 | 3 | 3 | 3 |
| | Component | 20 | 20 | 20 | 20 | 20 | 20 |
| | (A): A1 | | | | | | |
| Edible oil | Edible oil | 1 | 1 | 2 | 2 | 4 | 4 |
| or fat | or fat 1 | | | | | | |
| Others | Whole egg | 120 | 120 | 120 | 120 | 120 | 120 |
| | Processed oil | 120 | 120 | 120 | 120 | 120 | 120 |
| | or fat 1 | | | | | | |
| Total of powder raw material | | 223 | 223 | 223 | 223 | 223 | 223 |
| Total of food composition | | 464 | 464 | 465 | 465 | 467 | 467 |
| Component (A)/Cereal | | 20 | 20 | 20 | 20 | 20 | 20 |
| flour (% by mass) * | | | | | | | |
| Component (A)/Powder raw | | 8.97 | 8.97 | 8.97 | 8.97 | 8.97 | 8.97 |
| material (% by mass) ** | | | | | | | |
| Component (A)/Food | | 4.3 | 4.3 | 4.3 | 4.3 | 4.3 | 4.3 |
| composition (% by mass) *** | | | | | | | |
| Edible oil or | | 0.05 | 0.05 | 0.1 | 0.1 | 0.2 | 0.2 |
| fat/Component (A) **** | | | | | | | |
| Evaluation | Moist feeling | 2 | 5 | 2 | 5 | 2 | 5 |
| | Easiness to bite | 2 | 4 | 2 | 5 | 2 | 5 |
| | Crumbly texture | 2 | 5 | 2 | 5 | 2 | 5 |
| | Workability of | 4 | 4 | 3 | 4 | 3 | 4 |
| | food composition | | | | | | |

Note)
* Component (A)/Cereal flour (% by mass) refers to the mass (% by mass) of the component (A) to the cereal flour.
** Component (A)/Powder raw material (% by mass) refers to the mass (% by mass) of the component (A) to the entirety of the powder raw material.
*** Component (A)/Food composition (% by mass) refers to the mass (% by mass) of the component (A) to the entirety of the food composition.
**** Edible oil or fat/Component (A) refers to a mass ratio of the edible oil or fat to the component (A).

As shown in Table 3, it was found that madeleines of Examples 1 to 3 prepared by preparing the food composition by mixing the edible oil or fat 1 with the component A1 and then blending the mixture with a food material had excellent moist feeling, easiness to bite, and crumbly texture, as compared with Comparative Examples 1 to 3 in which the edible oil or fat 1 and the component A1 were not previously mixed.

The moist feeling, the crumbly texture, and the workability were good when the edible oil or fat/component (A) was equal to or more than 0.05 and equal to or less than 0.2.

The easiness to bite was good when the edible oil or fat/component (A) was equal to or more than 0.05 and equal to or less than 0.2, and was better when the edible oil or fat/component (A) was equal to or more than 0.1 and equal to or less than 0.2.

On the other hand, all of the madeleines obtained in the comparative examples were dry, and the easiness to bite and the crumbly texture were not so good.

### Experiment 2

In Example 3 of Experiment 1, madeleine was prepared and evaluated with the same operation, except that the edible oil or fat 1 was changed to the edible oil or fat 2. Evaluation results were shown in Table 4.

TABLE 4

| Raw material (part(s) by mass) | | Example 3 | Example 4 |
|---|---|---|---|
| Powder raw | Soft flour | 100 | 100 |
| material | Sugar 1 | 100 | 100 |
| | Baking powder | 3 | 3 |
| | Component (A): A1 | 20 | 20 |
| Edible oil or | Edible oil or fat 1 | 4 | |
| fat | Edible oil or fat 2 | | 4 |
| Others | Whole egg | 120 | 120 |
| | Processed oil or fat 1 | 120 | 120 |
| Total of powder raw material | | 223 | 223 |
| Total of food composition | | 467 | 467 |
| Component (A)/Cereal flour (% by mass) * | | 20 | 20 |
| Component (A)/Powder raw material | | 8.97 | 8.97 |
| (% by mass) ** | | | |
| Component (A)/Food composition | | 4.3 | 4.3 |
| (% by mass) *** | | | |
| Edible oil or fat/Component (A) **** | | 0.2 | 0.2 |
| Evaluation | Moist feeling | 5 | 3 |
| | Easiness to bite | 5 | 5 |
| | Crumbly texture | 5 | 4 |
| | Workability of food composition | 4 | 5 |

Note)
* Component (A)/Cereal flour (% by mass) refers to the mass (% by mass) of the component (A) to the cereal flour.
** Component (A)/Powder raw material (% by mass) refers to the mass (% by mass) of the component (A) to the entirety of the powder raw material.
*** Component (A)/Food composition (% by mass) refers to the mass (% by mass) of the component (A) to the entirety of the food composition.
**** Edible oil or fat/Component (A) refers to a mass ratio of the edible oil or fat to the component (A)

As shown in Table 4, it was found that madeleines of Examples 3 to 4 produced by preparing the food composition by mixing the edible oils or fats 1 and 2 with the component A1 and then blending the mixture with the food material had an excellent texture.

The moist feeling and the crumbly texture were good when the SFC of the edible oil or fat at 30° C. was equal to or more than 0% and equal to or less than 8.5%, and better when the SFC was 0%.

The easiness to bite was good when the SFC of the edible oil or fat at 30° C. was equal to or more than 0% and equal to or less than 8.5%.

### Experiment 3

In the present example, the financier was prepared and evaluated.

(Method for Producing Financier)

1. The component (A) and the edible oil or fat 1 were mixed according to a blend shown in Table 5, and further sheared using a food processor to obtain a mixture.

2. Soft flour, the baking powder, and sugar 2 were put in a plastic bag and mixed to obtain a mixed flour.

3. Egg white, water, the mixture obtained in 1, and the mixed flour obtained in 2 were placed in a bowl and stirred uniformly with a hobart mixer equipped with a beater.

4. Processed oil or fat 1 and Processed oil or fat 2 melted by heating at 50° C. was added, and was uniformly stirred.

5. The dough was placed at 25° C. for 1 hour.

6. The dough was put into a pastry bag, and the dough was poured into a Financier mold (8 pieces, length 260 mm, width 180 mm, height 15 mm, made of silicon-treated steel) and baked in an oven under the following conditions to obtain a financier.

Baking temperature: Upper part 180° C./Lower part 180° C.

Baking time: For 11 minutes

TABLE 5

| Raw material (part(s) by mass) | | Example 5 |
|---|---|---|
| Powder raw material | Soft flour | 100 |
| | Component (A): A1 | 40 |
| | Baking powder | 2 |
| | Sugar 2 | 100 |
| Edible oil or fat | Edible oil or fat 1 | 5 |
| Others | Processed oil or fat 1 | 120 |
| | Processed oil or fat 2 | 10 |
| | Whole egg | 100 |
| | Water | 20 |

| | |
|---|---|
| Total of powder raw material | 242 |
| Total of food composition | 497 |
| Component (A)/Cereal flour (% by mass) * | 40 |
| Component (A)/Powder raw material (% by mass) ** | 16.5 |
| Component (A)/Food composition (% by mass) *** | 8.0 |
| Edible oil or fat/Component (A) **** | 0.13 |

Note)
* Component (A)/Cereal flour (% by mass) refers to the mass (% by mass) of the component (A) to the cereal flour.
** Component (A)/Powder raw material (% by mass) refers to the mass (% by mass) of the component (A) to the entirety of the powder raw material.
*** Component (A)/Food composition (% by mass) refers to the mass (% by mass) of the component (A) to the entirety of the food composition.
**** Edible oil or fat/Component (A) refers to a mass ratio of the edible oil or fat to the component (A).

When eating the financier obtained by baking a food composition obtained by preparing the mixture of the present example and adding the mixture to the food material, and the financier was moist and had easiness to bite and crumbly texture, and had a good texture.

### Experiment 4

In the present example, a hamburger steak was prepared and evaluated. Table 6 shows a blend of the hamburger steak and evaluation results thereof.

(Method for Producing Hamburger Steak)

(Case of Example)

1. 1.5 parts by mass of the edible oil or fat 3 was mixed with 1 part by mass of the component (A) to obtain a mixture 1.

2. 2 parts by mass of water was further added to the mixture 1 of the above 1. to obtain a mixture 2.

3. Among the raw materials shown in Table 6, remaining raw materials were kneaded, and 4.5 parts by mass of the mixture 2 prepared in the above 2. was added and kneaded well again to prepare a hamburger steak patty.

4. 80 g of the hamburger steak patty is die-cut into a flat plate, baked on a hot plate at 200° C. for 1 minute each on the front and back, then steamed in a steam oven at 250° C. for 5 minutes, and allowed to cool at a room temperature for 30 minutes, and was used for a sensory evaluation.

(Case of Comparative Example)

The hamburger steak was obtained by the same operation, except that, in (Case of Example), the operations in 1 and 2 were not performed, and the operation in 3 was set such that “Among the raw materials shown in Table 6, raw materials other than the edible oil or fat 3 were kneaded, and the edible oil or fat 3 was added thereto and kneaded well again to prepare a hamburger steak patty”.

The obtained hamburger steak was eaten, and the moist feeling, the easiness to bite, and the crumbly texture were evaluated by the following evaluation criteria by the consensus of four specialized panelists. In addition, the workability of the food composition was evaluated by one worker from the viewpoint of stickiness of the dough. A score of equal to or higher than 3 was set as a pass.

(Moist Feeling)

5: Very moist

4: Moist

3: Slightly moist

2: Feel slightly dryness

1: Feel considerable dryness

(Easiness to Bite)

5: Very easy to bite

4: Easy to bite

3: Slightly easy to bite

2: Not very easy to bite

1: Not easy to bite

(Crumbly Texture)

5: Crumbly texture is very strong

4: Crumbly texture is strong

3: Crumbly texture is slight

2: Crumbly texture is weak

1: Crumbly texture is none

(Workability of Food Composition)

5: No stickiness at all

4: Almost no stickiness

3: Not very sticky

2: Slightly sticky

1: Very sticky

TABLE 6

| | | | Comparative |
|---|---|---|---|
| Raw material (part(s) by mass) | | Example 6 | Example 4 |
| Beef and pork kneaded meat | | 68.0 | 68.0 |
| Sauteed onion | | 15.0 | 15.0 |
| Egg liquid | | 8.5 | 8.5 |
| Bread crumbs | | 5.5 | 5.5 |
| Common salt | | 0.8 | 0.8 |
| Nutmeg | | 0.1 | 0.1 |
| Pepper | | 0.1 | 0.1 |
| Component (A): A2 | | 1.0 | 1.0 |
| Edible oil or fat: Edible oil or fat 3 | | 1.5 | 1.5 |
| Water | | 2.0 | 2.0 |
| Total of food composition | | 102.5 | 102.5 |
| Component (A)/Food composition | | 0.98 | 0.98 |
| (% by mass) * | | | |
| Edible oil or fat/Component (A) ** | | 1.5 | 1.5 |
| Water/Component (A) *** | | 2.0 | 2.0 |
| Evaluation | Moist feeling | 3 | 3 |
| | Easiness to bite | 4 | 2 |
| | Crumbly texture | 4 | 2 |
| | Workability of food composition | 3 | 3 |

Note)
* Component (A)/Food composition (% by mass) refers to the mass (% by mass) of the component (A) to a total of the food composition.
** Edible oil or fat/Component (A) refers to a mass ratio of the edible component to the component (A).
*** Water/Component (A) refers to a mass ratio of water to the component (A).

As shown in Table 6, the hamburger steak prepared by mixing the edible oil or fat 3 with the component A2 and then blending the mixture with the food material had a good texture such as easiness to bite and the crumbly texture. On the other hand, in Comparative Example 4 in which the edible oil or fat 3 and the component A2 were not previously mixed, the hamburger steak was too soft and the easiness to bite was not so good, and a feeling of crumbly breaking was weak.

### Experiment 5

In Example 6, a hamburger steak was obtained by the same operation as in Example 6 except that 4.0 parts by mass of the edible oil or fat 3 and 1.0 part by mass of the water were used. When the hamburger steak was eaten, the hamburger steak had a good texture such as the easiness to bite and a crumbly texture.

### Experiment 6

(Soybean Hamburger Steak)

4 parts by mass of the edible oil or fat 3 and 2 parts by mass of the component A2 were previously mixed to obtain a mixture.

80 parts by mass of boiled soybeans was made into a paste with a food processor, 20 parts by mass of chopped onions, 8 parts by mass of bread crumbs, and a seasoning were added and mixed well. 6 parts by mass of the mixture was added thereto, and the mixture was further mixed. When a soybean hamburger steak, which is a processed livestock meat product-like food, was prepared by shaping and baking, the texture such as the crumbly texture was good.

### Preparation Example 1 of Composition

40 g of the component A1 and 20 g of a corn oil (SFC at 30° C. and 10° C. were both 0% and the slip melting point was lower than 0° C.) were mixed to obtain the composition of the present example.

### Preparation Example 2 of Composition

40 g of the component A2 and 40 g of a soybean oil (SFC at 30° C. and 10° C. were both 0% and the slip melting point was lower than 0° C.) were mixed to obtain the composition of the present example.

### Preparation Example 3 of Composition

40 g of the component A1 and 60 g of a corn oil were mixed and 20 g of liquid seasoning (obtained by dissolving commercially available consomme in water) was further mixed to obtain the composition of the present example.

As described above, it was found that in the food obtained by the method for producing a food of the present example, it is possible to improve the texture such as the crumbly texture, in any form of the baked confectionery and the processed fish or livestock meat product or the processed fish or livestock meat product-like food.

### Experiment 7

A madeleine was prepared and evaluated with the same operation as Experiment 1, except that the blend in Experiment 1 was changed to those shown in Table 7. However, the number of specialized panelists was eight. Evaluation criteria are shown below.

Results were shown in Table 7.

(Method for Producing Madeleine)

(Case of Examples)

1. According to the blend in Table 7, the component (A) and the edible oil or fat were mixed in Example A, and the component (A), the edible oil or fat 1, and the corn starch (described as “mixed in mixture” in Table 7) were mixed in Examples B to D, and the mixture was further sheared using a food processor to obtain each mixture.

2. In Examples A to C, the corn starch (described as “mixed in powder” in Table 7), soft flour, baking powder, and sugar 1 were placed in a plastic bag and mixed to obtain a mixed flour. In Example D, soft flour, baking powder, and sugar 1 were placed in a plastic bag and mixed to obtain a mixed flour.

3. The whole egg, the mixture obtained in 1., and the mixed flour obtained in 2. were placed in a bowl and stirred uniformly with a hobart mixer equipped with a beater.

4. Processed oil or fat 1 melted by heating at 50° C. was added, and was uniformly stirred.

5. The dough was placed at 25° C. for 1 hour.

6. The dough was put into a pastry bag, and the dough was poured into a madeleine mold (12 pieces, length 260 mm, width 180 mm, height 15 mm, made of silicon-treated tin) and baked in an oven under the following conditions to obtain a madeleine.

Baking temperature: Upper part 180° C./Lower part 200° C.

Baking time: For 17 minutes

(Case of Control Example)

A madeleine was obtained with the same operation, except that, in (Case of Example), an operation of 1. was not performed, and a mixed flour was obtained with the same operation as Examples A to C in 2. and an operation of 3. was set such that “the component (A) and the edible oil or fat 1 were added to the whole egg, were placed in a bowl together with mixed flour obtained in 2, and stirred uniformly with a hobart mixer equipped with a beater.”

(Evaluation Method)

The madeleines prepared in each example were evaluated by the same means as in Experiment 1 except that there were 5 specialized panelists. Evaluation results were shown in Table 7.

TABLE 7

| | | | | | | Control |
|---|---|---|---|---|---|---|
| | | Example A | Example B | Example C | Example D | Example 1 |
| Component | Soft flour | 100 | 100 | 100 | 100 | 100 |
| (part(s) by | Sugar 1 | 100 | 100 | 100 | 100 | 100 |
| mass) | Baking powder | 3 | 3 | 3 | 3 | 3 |
| | Component (A): A1 | 10 | 10 | 10 | 10 | 10 |
| | Edible oil or fat 1 | 2 | 2 | 2 | 2 | 2 |
| | Corn starch (mixed in mixture) | 0 | 10 | 15 | 30 | — |
| | Corn starch (mixed in powder) | 30 | 20 | 15 | 0 | 30 |
| | Whole egg | 120 | 120 | 120 | 120 | 120 |
| | Processed oil or fat 1 | 120 | 120 | 120 | 120 | 120 |
| | Total of powder raw material | 243 | 243 | 243 | 243 | 243 |
| Total of dough (part(s) by mass) | | 485 | 485 | 485 | 485 | 485 |
| Component (A)/Cereal flour (% by mass) * | | 10 | 10 | 10 | 10 | 10 |
| Component (A)/Powder raw material (% by mass) ** | | 4.1 | 4.1 | 4.1 | 4.1 | 4.1 |
| Component (A)/Food composition (% by mass) *** | | 2.1 | 2.1 | 2.1 | 2.1 | 2.1 |
| Edible oil or fat/Component (A) (mass ratio) **** | | 0.20 | 0.20 | 0.20 | 0.20 | 0.20 |
| Evaluation | Moist feeling | 3 | 3 | 3 | 3 | 2 |
| | Easiness to bite | 3 | 3 | 3 | 3 | 2 |
| | Crumbly texture | 5 | 4 | 4 | 3 | 2 |
| | Workability of food composition | 3 | 3 | 3 | 3 | 3 |

Note)
* Component (A)/Cereal flour (% by mass) refers to the mass (% by mass) of the component (A) to the cereal flour.
** Component (A)/Powder raw material (% by mass) refers to the mass (% by mass) of the component (A) to the entirety of the powder raw material.
*** Component (A)/Food composition (% by mass) refers to the mass (% by mass) of the component (A) to the entirety of the food composition.
**** Edible oil or fat/Component (A) refers to a mass ratio of the edible oil or fat to the component (A).

The madeleines to which the mixture of Examples A to D was blended had excellent moist feeling, easiness to bite, and crumbly texture, as compared with the control example, and also had good workability.

In addition, even in a case where the mixture of Examples B to D containing other components in addition to the component (A) and the edible oil or fat is blended in the mixture, the obtained madeleine had excellent moist feeling, easiness to bite, and crumbly texture, and workability as compared with the control example.

Priority is claimed on Japanese Patent Application No. 2018-147253, filed on Aug. 3, 2018, the entire disclosure of which is incorporated herein.

1. A method for producing a food, comprising:
obtaining a mixture by mixing an edible oil or fat and a component (A) that satisfies conditions of (1) to (4) below; and
obtaining a food composition by blending the mixture in a food material,
wherein in the obtaining the mixture, a blending amount of the edible oil or fat is equal to or more than 0.02 and equal to or less than 6 in terms of a mass ratio, with respect to the component (A), and a total amount of the edible oil or fat and the component (A) in the mixture is equal to or more than 10% by mass and equal to or less than 100% by mass, with respect to an entirety of the mixture,
(1) a starch content is equal to or more than 75% by mass,
(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴,
(3) a degree of swelling in cold water at 25° C. is equal to or more than 5 and equal to or less than 20, and
(4) a content under a sieve having an opening of 3.35 mm and on a sieve having an opening of 0.038 mm is equal to or more than 60% by mass and equal to or less than 100% by mass.

2. The production method according to claim 1,
wherein the blending amount of the component (A) is equal to or more than 0.5% by mass and equal to or less than 15% by mass in the food composition.

3. The production method according to claim 1,
wherein the food is obtainable by heating the food composition.

4. The production method according to claim 1,
wherein the food is one selected from the group consisting of a baked confectionery, a processed fish or livestock meat product, a processed fish or livestock meat product-like food, and a bakery food.

5. The production method according to claim 1,
wherein a solid fat content of the edible oil or fat at 30° C. is equal to or more than 0% and equal to or less than 20%.

6. A composition comprising:
an edible oil or fat; and
a component (A) that satisfies conditions of (1) to (4) below,
wherein a blending amount of the edible oil or fat is equal to or more than 0.02 and equal to or less than 6 in terms of a mass ratio, with respect to the component (A), and
a total amount of the edible oil or fat and the component (A) in the composition is equal to or more than 10% by mass and equal to or less than 100% by mass with respect to an entirety of the composition,
(1) a starch content is equal to or more than 75% by mass,
(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴,
(3) a degree of swelling in cold water at 25° C. is equal to or more than 5 and equal to or less than 20, and
(4) a content under a sieve having an opening of 3.35 mm and on a sieve having an opening of 0.038 mm is equal to or more than 60% by mass and equal to or less than 100% by mass.

7. The composition according to claim 6,
wherein the composition is used for one selected from the group consisting of a baked confectionery, a processed fish or livestock meat product, a processed fish or livestock meat product-like food, and a bakery food.

8. A method for improving a texture of a food, comprising:
obtaining a food composition by blending, in a food material, a mixture which is obtained by mixing an edible oil or fat with a component (A) that satisfies conditions of (1) to (4) below such that a mass ratio is equal to or more than 0.02 and equal to or less than 6,
wherein a total amount of the edible oil or fat and the component (A) in the mixture is equal to or more than 10% by mass and equal to or less than 100% by mass, with respect to an entirety of the mixture,
(1) a starch content is equal to or more than 75% by mass,
(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴,
(3) a degree of swelling in cold water at 25° C. is equal to or more than 5 and equal to or less than 20, and
(4) a content under a sieve having an opening of 3.35 mm and on a sieve having an opening of 0.038 mm is equal to or more than 60% by mass and equal to or less than 100% by mass.

9. The method according to claim 8,
wherein the blending amount of the component (A) is equal to or more than 0.5% by mass and equal to or less than 15% by mass in the food composition.
